(19) United States
(12) Patent Application Publication
(10) Pub. No.: US 2018/0313250 A1
(43) Pub. Date: Nov. 1, 2018

(54) COOLING STRUCTURE FOR INTERNAL COMBUSTION ENGINE

(71) Applicant: TOYOTA JIDOSHA KABUSHIKI KAISHA, Toyota-shi (JP)

(72) Inventors: Masao NAKAYAMA, Nagoya-shi (JP); Masahiko ASANO, Toyota-shi (JP)

(73) Assignee: TOYOTA JIDOSHA KABUSHIKI KAISHA, Toyota-shi (JP)

(21) Appl. No.: 15/949,318

(22) Filed: Apr. 10, 2018

(30) Foreign Application Priority Data
Apr. 27, 2017 (JP) 2017-088823

(51) Int. Cl. F01P 3/16; F02F 1/40; F02F 1/24; F02F 11/00; F02M 53/04; F01P 3/02

(52) U.S. Cl. CPC F01P 3/16; F02F 1/40; F02F 1/242; F02F 2001/104; F02M 53/043; F01P 3/02; F02F 11/002

(57) ABSTRACT

The cooling structure for internal combustion engine includes: a cylinder head including a fixing part for fuel injection valve of a cylinder-direct-injection type; a cylinder block; and a water jacket spacer. A surface on a cylinder block side of the cylinder head is recessed so as to be sectioned into a recessed coolant passage communicating with a block-side water jacket formed in the cylinder block. The recessed coolant passage surrounds periphery of the fixing part for the fuel injection valve. An edge on a cylinder head side of the water jacket spacer that is disposed in the block-side water jacket is provided with projection projecting toward the recessed coolant passage so as to direct at least part of the coolant flowing inside the block-side water jacket toward the recessed coolant passage.

### INCORPORATION BY REFERENCE

The disclosure of Japanese Patent Application No. 2017-088823 filed on Apr. 27, 2017 including the specification, drawings and abstract is incorporated herein by reference in its entirety.

### BACKGROUND

### 1. Technical Field

The present disclosure relates to a cooling structure for an internal combustion engine. In particular, the present disclosure relates to improvement of a structure for cooling fuel injection valves in a cylinder-direct-injection type internal combustion engine.

### 2. Description of Related Art

In a conventional internal combustion engine of a cylinder-direct-injection type, since front ends of nozzles of fuel injection valves (injectors) face combustion chambers, the front ends of these nozzles are likely to have a high temperature, and due to this, alteration products of a fuel (carbon deposits, hereinafter, referred to simply as deposits) are likely to be accumulated around injection holes of the nozzles. If such deposit accumulation occurs, a proper amount of fuel injection might not be obtained. Hence, in a cylinder-direct-injection type engine, a configuration that cools injectors with an engine coolant (hereinafter, referred to simply as a coolant) may be employed.

For example, Japanese Patent Application Publication No. 2007-231896 (JP 2007-231896 A) discloses a configuration in which a gasket interposed between a cylinder block and a cylinder head is formed with small-diameter communication holes that oppose injector support parts, and water jackets that are separately formed in the cylinder block and the cylinder head are allowed to communicate with each other through these communication holes. Through this configuration, part of the coolant flowing through the water jacket of the cylinder block (the block-side water jacket) is brought to flow toward the injector support parts (to flow in a direction orthogonal to the cylinder alignment direction), and is introduced into the water jacket of the cylinder head (the head-side water jacket) so as to cool the injectors with this coolant.

### SUMMARY

Unfortunately, in the configuration in JP 2007-231896 A, a flow of part of the coolant flowing through the block-side water jacket is greatly changed toward the injector support parts; thus, disturbance is likely to be caused to the coolant flow in the head-side water jacket, which might cause decrease in flow rate of the coolant. Hence, the configuration of JP 2007-231896 A cannot secure a sufficient cooling performance for the injectors.

The present disclosure provides a cooling structure for an internal combustion engine capable of providing a sufficient cooling performance for injectors.

An aspect of the present disclosure is a cooling structure for an internal combustion engine, allowing a coolant to flow along respective periphery of a fixing part for fuel injection valve so as to cool the fuel injection valve. The cooling structure includes a cylinder head including the fixing part for the fuel injection valve of a cylinder-direct-injection type; a cylinder block; and a water jacket spacer. This cooling structure for the internal combustion engine is such that a surface on a cylinder block side of the cylinder head is recessed so as to be sectioned into a recessed coolant passage communicating with a block-side water jacket formed in the cylinder block, the recessed coolant passage surrounding periphery of the fixing part for the fuel injection valve, and an edge on the cylinder head side of the water jacket spacer that is disposed in the block-side water jacket is provided with a projection projecting toward the recessed coolant passage so as to direct at least part of the coolant flowing inside the block-side water jacket toward the recessed coolant passage.

According to this structure, at least part of the coolant flow flowing inside the block-side water jacket is directed toward the recessed coolant passage (the recessed coolant passage formed by recessing the cylinder-block-side surface of the cylinder head, the recessed coolant passage surrounding periphery of the fixing part for the fuel injection valve) by the projection provided on the water jacket spacer. That is, since the coolant is smoothly guided by the projection provided on the water jacket spacer into the recessed coolant passage, it is suppressed that the flow rate becomes decreased due to disturbance caused to the coolant flow flowing along the periphery of the fixing part for the fuel injection valve. Accordingly, the coolant flows along the periphery of the fixing part for the fuel injection valve at a relatively high flow rate, to thereby provide a sufficient cooling performance for the fuel injection valve.

In the cooling structure for the internal combustion engine, the internal combustion engine may be a multiple-cylinder internal combustion engine. In the block-side water jacket, the coolant may flow along a cylinder alignment direction, a gasket interposed between the cylinder block and the cylinder head may be formed with communication holes corresponding to the recessed coolant passages, and a length dimension in the cylinder alignment direction of each of the communication holes of the gasket may coincide with a length dimension in the cylinder alignment direction of each of the recessed coolant passages.

According to this structure, it is possible to set the length dimension in the cylinder alignment direction of each of the communication holes formed in the gasket to be relatively long, and thus it is possible to almost prevent the direction in the flow of the coolant flowing from the block-side water jacket into the recessed coolant passages from being changed. Therefore, it is possible to enhance reliability for the coolant flow flowing at a relatively high flow rate along the peripheries of the fixing parts for the fuel injection valves, to thus provide a sufficient cooling performance for the fuel injection valves.

The cylinder head may be formed with a head-side water jacket that communicates with the block-side water jacket, and the recessed coolant passage may not communicate with the head-side water jacket, inside the cylinder head.

In the related art, the coolant passage, which allows the coolant to flow along the periphery of the fixing part for the fuel injection valve, and the head-side water jacket are brought to communicate with each other inside the cylinder head. Hence, the coolant passage allowing them to communicate with each other is additionally required; thus the capacity of the coolant passage in the entire cylinder head tends to be larger. Consequently, the amount of the coolant is relatively large. To the contrary, according to the present solution, since the recessed coolant passage does not communicate with the head-side water jacket, it is possible to reduce the capacity of the coolant passage in the entire cylinder head, thus reducing the amount of the coolant. Accordingly, it is possible to rapidly increase the temperature of the coolant during the warm-up running of the internal combustion engine, to thereby promote improvement of a specific fuel consumption because of reduction of the warm-up running time.

The recessed coolant passage may be provided with a branch passage allowing the coolant to flow toward a side opposite to the cylinder block in the fixing part for the fuel injection valve.

According to this structure, it is possible to allow the coolant to flow along the entire circumference of the fixing part for the fuel injection valve. That is, it is possible to cool the fuel injection valve from the entire circumference thereof. Accordingly, it is possible to promote further enhancement of the cooling performance for the fuel injection valve.

In the present disclosure, the surface on the cylinder block side of the cylinder head is recessed to form the recessed coolant passage surrounding the periphery of the fixing part for the fuel injection valve; and the projection is provided on the edge on the cylinder head side of the water jacket spacer so as to direct at least part of the coolant flowing inside the block-side water jacket toward the recessed coolant passage. Accordingly, it is possible to allow the coolant to flow along the periphery of the fixing part for the fuel injection valve at a relatively high flow rate, to thus provide a sufficient cooling performance for the fuel injection valve.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view showing an engine body;

FIG. 2 is a perspective view showing a bottom surface of a cylinder head;

FIG. 3 is a bottom view of the cylinder head;

FIG. 4 is an enlarged view showing a major part of the bottom surface of the cylinder head;

FIG. 5 is a sectional view of the engine body at a position corresponding to a line V-V in FIG. 4; and

FIG. 6 is a view corresponding to FIG. 5 in a variation.

### DETAILED DESCRIPTION OF EMBODIMENTS

Hereinafter, embodiments of the present disclosure will be described with reference to the drawings. In the present embodiment, the case of applying the present disclosure to an inline 4-cylinder gasoline engine will be described.

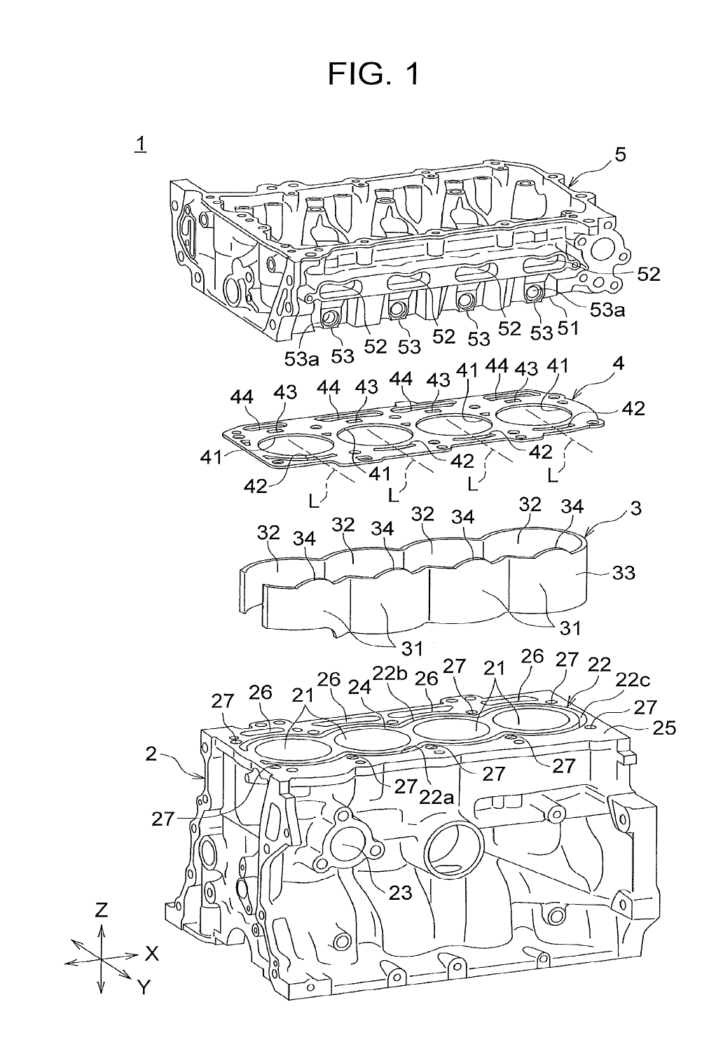

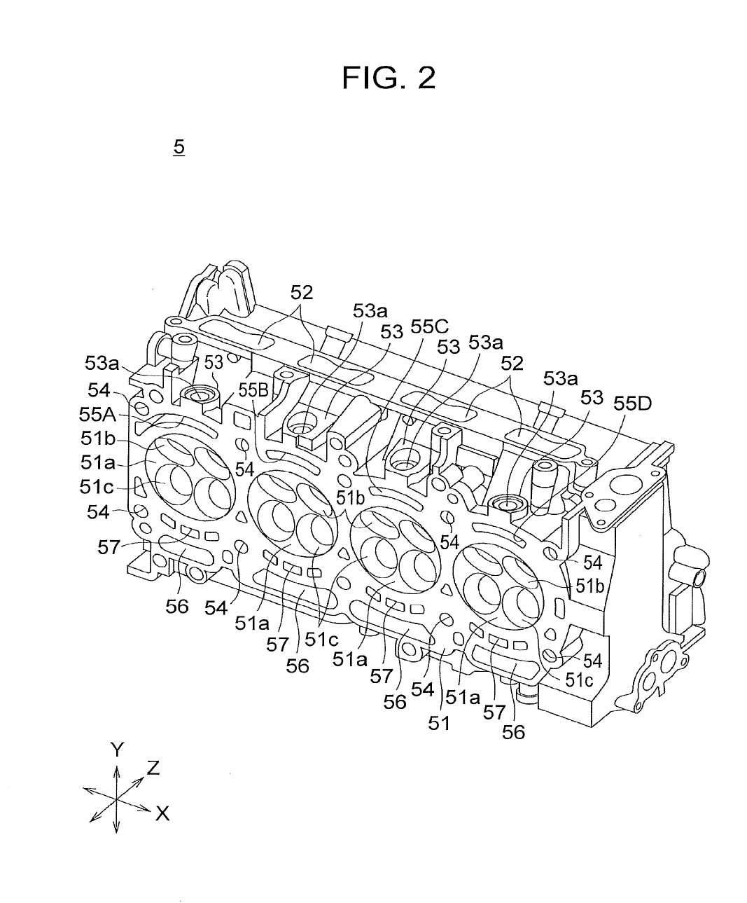

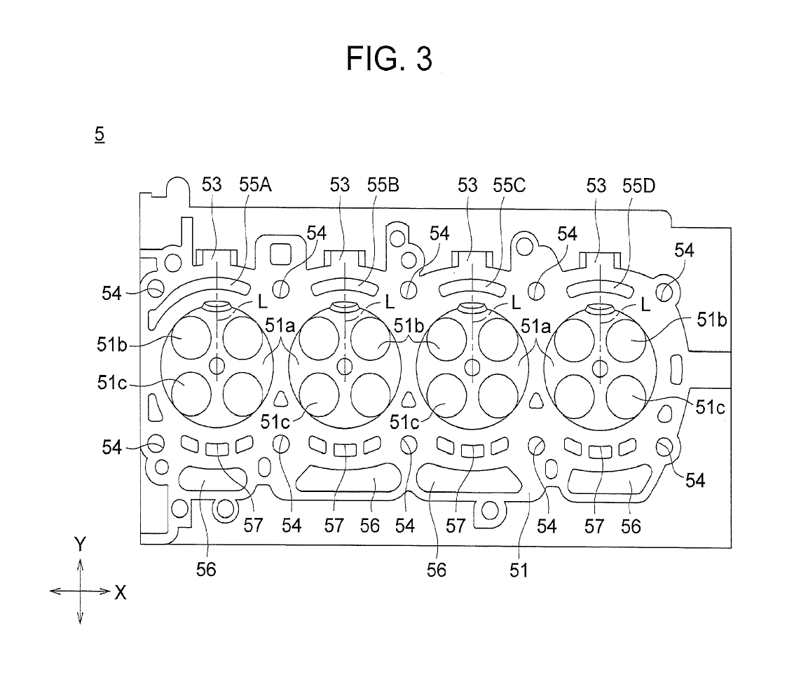

FIG. 1 is an exploded perspective view showing an engine body 1 in the present embodiment. FIG. 2 is a perspective view showing a bottom surface 51 of a cylinder head 5. FIG. 3 is a bottom view of the cylinder head 5.

As shown in FIG. 1, the engine body 1 is composed by integrally assembling a cylinder block 2, a water jacket spacer 3, a gasket 4, and the cylinder head 5.

Specifically, the engine body 1 is configured such that a water jacket spacer 3 is disposed in a water jacket 22 formed in the cylinder block 2 (hereinafter, referred to as a block-side water jacket 22), and the cylinder block 2 and the cylinder head 5 are integrally assembled through bolting with the gasket 4 interposed between a top surface (a deck surface) 25 of the cylinder block 2 and the bottom surface 51 of the cylinder head 5.

Cylinder block—The cylinder block 2 is composed by a metallic material, such as a cast iron and an aluminum alloy. The cylinder block 2 is formed with multiple (four in the present embodiment) cylinder bores 21, 21, . . . , the block-side water jacket 22, and a coolant introducing passage 23.

Each of the cylinder bores 21, 21, . . . is a columnar space for accommodating a piston (not illustrated) thereinside. These cylinder bores 21, 21, . . . are arranged in series along the longitudinal direction (the X-direction in FIG. 1) of the cylinder block 2.

The block-side water jacket 22 is a space (a groove) formed from one end side to the other end side in the arrangement direction (hereinafter, referred to as a cylinder alignment direction) of the cylinder bores 21, 21, . . . in such a manner as to surround the cylinder bores 21, 21, . . . . In the following description, one side (the left side in FIG. 1) in the cylinder alignment direction is referred to as a “front side”, and the other side (the right side in FIG. 1) in the cylinder alignment direction is referred to as a “rear side”, for convenience of explanation.

The cylinder block 2 in the present embodiment is of a so-called open-deck type, and the block-side water jacket 22 opens to the deck surface 25 of the cylinder block 2. This opening part of the block-side water jacket 22 is partially covered with the gasket 4 when the gasket 4 is assembled to the deck surface 25 of the cylinder block 2 (the shape of the gasket 4 will be described later).

The block-side water jacket 22 includes: an intake-side water jacket part 22a formed along outer circumferences of the cylinder bores 21, 21, . . . on the intake side (a front side of the cylinder block 2 in FIG. 1, a front side in the Y-direction in the drawing); an exhaust-side water jacket part 22b formed along outer circumferences of the cylinder bores 21, 21, . . . on the exhaust side (a rear side of the cylinder block 2 in FIG. 1, a rear side in the Y-direction in the drawing); and a connecting part 22c that allows the intake-side water jacket part 22a and the exhaust-side water jacket part 22b to communicate with each other on the rear side.

In the cylinder block 2, a cylinder bore wall 24 formed between the respective cylinder bores 21, 21, . . . and the block-side water jacket 22 is cooled by the coolant flowing through the block-side water jacket 22.

The coolant introducing passage 23 is a passage serving for introducing the coolant supplied from the outside of the cylinder block 2, from the front side into the block-side water jacket 22. A not-illustrated coolant circulation circuit is connected to the coolant introducing passage 23, and the coolant is introduced toward the block-side water jacket 22 by operation of a water pump provided in this coolant circulation circuit. As the water pump, there may be employed either one of a mechanical water pump operated by receiving driving force of an engine and an electric water pump operated by an electric motor.

On the exhaust side of the cylinder bores 21, 21, . . . in the cylinder block 2, there are formed oil return passages 26, 26, . . . that allow a lubrication oil to flow down to a not-illustrated oil pan.

Gasket—The gasket 4 serves for preventing a combustion gas, the coolant, and the oil from leaking out from between the deck surface 25 of the cylinder block 2 and the bottom surface 51 of the cylinder head 5, and has a structure including multiple stacked mild steel plates or stainless steel plates.

This gasket 4 is formed with bore openings 41, 41, . . . corresponding to the respective cylinder bores 21, 21, . . . , communication holes 42, 42, . . . , 43, 43, . . . corresponding to part of the opening part of the block-side water jacket 22, and oil return holes 44, 44, . . . corresponding to the oil return passages 26, 26, . . . , 56, 56, . . . (with respect to the oil return passages 56, 56, . . . of the cylinder head 5, see FIG. 2 and FIG. 3) respectively formed in the cylinder block 2 and the cylinder head 5.

As the communication holes 42, 42, . . . , 43, 43, . . . formed in the gasket 4, there are provided intake-side communication holes 42, 42, . . . formed on the intake side (the front side in the Y-direction in FIG. 1) and exhaust-side communication holes 43, 43, . . . formed on the exhaust side (the rear side in the Y-direction in FIG. 1), respectively.

The intake-side communication holes 42, 42, . . . are openings to introduce part of the coolant flowing through the intake-side water jacket part 22a toward the cylinder head 5 side. The exhaust-side communication holes 43, 43, . . . are openings to introduce part of the coolant flowing through the exhaust-side water jacket part 22b toward the cylinder head 5 side. That is, most of the coolant introduced via the coolant introducing passage 23 to the block-side water jacket 22 flows along the outer circumferences of the cylinder bores 21, 21, . . . in the cylinder alignment direction. In addition, part of the coolant flowing along the outer circumferences of the cylinder bores 21, 21, . . . , namely the part of the coolant flowing through the intake-side water jacket part 22a, is introduced via the intake-side communication holes 42, 42, . . . toward the cylinder head 5 side (the coolant flow introduced toward the cylinder head 5 side will be described later). Further, part of the coolant flowing along the outer circumferences of the cylinder bores 21, 21, . . . , the part of the coolant flowing through the exhaust-side water jacket part 22b, is introduced via the exhaust-side communication holes 43, 43, . . . toward the cylinder head 5 side.

This gasket 4 has such a feature that a length in the cylinder alignment direction of each of the intake-side communication holes 42, 42, . . . is set to be relatively long. Specifically, the intake-side communication holes 42, 42, . . . are arranged in such a manner as to extend across respective reference lines L, L, . . . extending in the Y-direction (a horizontal direction orthogonal to the cylinder alignment direction (the X-direction)) from centers of the bores of the respective cylinders, and are composed by holes, each in an arc shape, extending along respective outer edges of the bore openings 41, 41, . . . , and a length of each arc is set to be relatively long. In particular, in the present embodiment, a length of an arc of the intake-side communication hole 42 corresponding to the first cylinder (the cylinder located at a leftmost position in FIG. 1) is set to be longer than lengths of arcs of the intake-side communication holes 42, 42, 42 corresponding to the other cylinders (the second cylinder to the fourth cylinder). The length of the arc of the intake-side communication hole 42 corresponding to the first cylinder is set such that an arc angle relative to the bore center of the first cylinder is 90°, for example. The length of the arc of each of the intake-side communication holes 42, 42, 42 corresponding to the other cylinders (the second cylinder to the fourth cylinder) is set such that an arc angle relative to the bore center of this cylinder is 50°, for example. These values are not limited to the above numerical values.

Cylinder head—The cylinder head 5 is provided on its upper part with members of a valve train such as not-illustrated cam shafts; and in the meantime, as shown in FIG. 2 and FIG. 3, recessed parts 51a, 51a, . . . forming combustion chambers corresponding to the cylinder bores 21, 21, . . . are formed in the bottom surface 51. Respective inner surfaces of these recessed parts 51a, 51a, . . . are formed with intake valve holes 51b, 51b, . . . opened and closed by not-illustrated intake valves, and are also formed with exhaust valve holes 51c, 51c, . . . opened and closed by not-illustrated exhaust valves in the respective cylinders, so that two valve holes are formed in each cylinder.

Four intake ports 52, 52, . . . corresponding to the respective cylinders are opened on a side surface (a side surface on the front side in the Y-direction in FIG. 1, a surface located on the upper side in the Y-direction in FIG. 2) on the intake side of the cylinder head 5. Each of the intake ports 52, 52, . . . is branched into two to communicate with the intake valve holes 51b, 51b, . . . of the corresponding cylinder so as to introduce the air introduced from not-illustrated intake manifolds into the insides of the cylinder bores 21, 21, . . . .

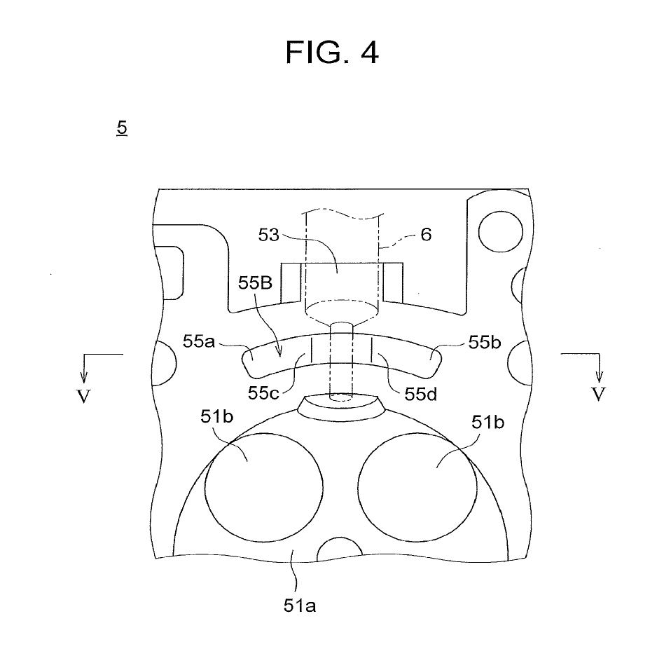

In addition, below the opening positions of the intake ports 52, 52, . . . in the cylinder head 5, there are provided injector fixing parts 53, 53, . . . to which injectors (fuel injection valves) 6 (see imaginary lines in FIG. 4 (an enlarged view of a major part of the bottom surface of the cylinder head 5 (of the second cylinder))) are to be fixed. Each of the injector fixing parts 53, 53, . . . includes a through-hole 53a extending through the cylinder head 5 from the side surface on the intake side to the inner surface of each recessed part 51a of the cylinder head 5; and the injector 6 is inserted into this through-hole 53a so as to be held therein. This through-hole 53a is provided between the intake valve holes 51b and 51b of each cylinder. Hence, injection fuel from the injector 6 held by the injector fixing part 53 is injected from between these intake valve holes 51b and 51b toward the inside of each cylinder.

Furthermore, this cylinder head 5 is formed with head bolt holes 54, 54, . . . through which head bolts (not illustrated) used for assembling the cylinder head 5 to the cylinder block 2 are inserted. These head bolt holes 54, 54, . . . are provided at positions corresponding to bolt holes 27, 27, . . . (see FIG. 1) formed in the cylinder block 2.

In addition, a head-side water jacket (not illustrated) is provided at a position closer to the exhaust side than the recessed parts 51a, 51a, . . . inside the cylinder head 5. This head-side water jacket is formed with coolant introduction holes 57, 57, . . . (see FIG. 2 and FIG. 3) opening to the bottom surface 51 of the cylinder head 5, in correspondence to the exhaust-side communication holes 43, 43, . . . of the gasket 4. Through this, as aforementioned, part of the coolant flowing through the exhaust-side water jacket part 22b of the cylinder block 2 is introduced via the exhaust-side communication holes 43, 43, . . . and the coolant introduction holes 57, 57, . . . into the head-side water jacket so as to cool the cylinder head 5.

The cylinder head 5 has such a feature that the bottom surface 51 of the cylinder head 5, located at a position closer to the intake side than the recessed parts 51a, 51a, . . . , is recessed so as to form recessed coolant passages 55A, 55B, 55C, 55D. These recessed coolant passages 55A, 55B, 55C, 55D are formed as coolant passages independent from (that do not communicate with) the head-side water jacket.

In the state in which the respective injectors 6 are inserted in the corresponding through-hole 53a, the recessed coolant passages 55A, 55B, 55C, 55D are formed at positions corresponding to respective front ends of the injectors 6, the positions also being corresponding to the intake-side communication holes 42, 42, . . . formed in the gasket 4. This means that the length in the cylinder alignment direction of each of the recessed coolant passages 55A, 55B, 55C, 55D is set to be relatively long. Specifically, the recessed coolant passages 55A, 55B, 55C, 55D are arranged in such a manner as to extend across the respective reference lines L, L, . . . (see FIG. 3) extending in the Y-direction from the centers of the bores of the respective cylinders, and are composed by recessed parts, each in an arc shape, extending along respective outer edges of the recessed parts 51a, 51a, . . . , and a length of each arc is set to be relatively long. In particular, in the present embodiment, a length of the arc of the recessed coolant passage 55A corresponding to the first cylinder (the cylinder located at the leftmost position in FIG. 3) is set to be longer than lengths of the arcs of the recessed coolant passages 55B, 55C, 55D corresponding to the other cylinders (the second cylinder to the fourth cylinder). The length of the arc of the recessed coolant passage 55A corresponding to the first cylinder is set such that the arc angle relative to the bore center of the first cylinder is 90°, for example, as with the intake-side communication hole 42 corresponding to the first cylinder. In addition, each of lengths of the arcs of the recessed coolant passages 55B, 55C, 55D corresponding to the other cylinders (the second cylinder to the fourth cylinder) is set such that the arc angle relative to the bore center of this cylinder is 50°, for example, as with the intake-side communication holes 42, 42, 42 corresponding to the second cylinder to the fourth cylinder. These values are not limited to the above numeral values. Since the recessed coolant passages 55A, 55B, 55C, 55D are formed in this manner, the length dimension (the length of the arc) in the cylinder alignment direction of each of the intake-side communication holes 42, 42, . . . of the gasket 4 substantially coincides with the length dimension (the length of the arc) in the cylinder alignment direction of each of the recessed coolant passages 55A, 55B, 55C, 55D.

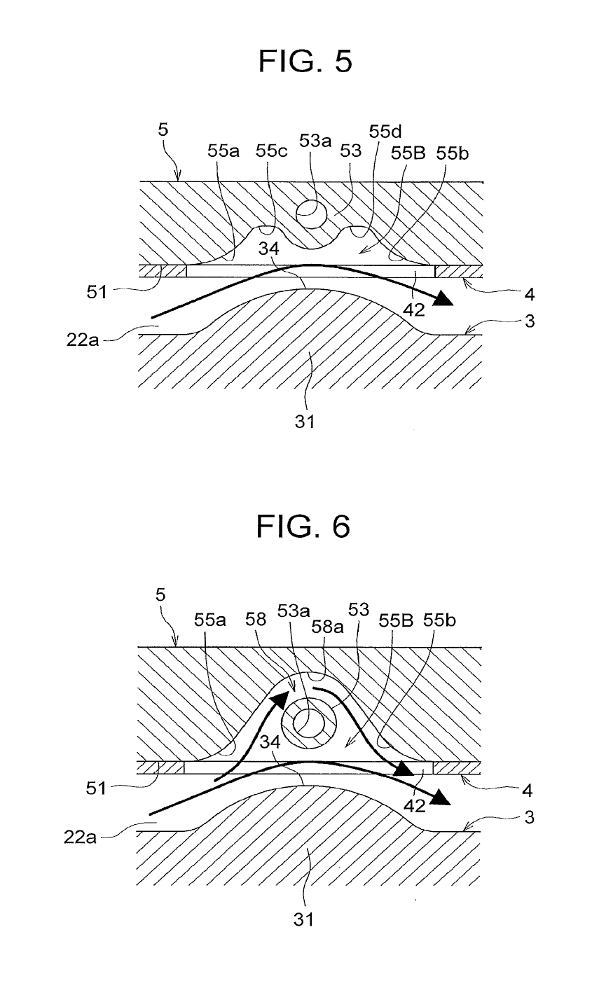

As shown in FIG. 5 (a sectional view of the engine body 1 at a position corresponding to line V-V in FIG. 4; a sectional view of the second cylinder in this example), both ends in the longitudinal direction of the inner surface of the recessed coolant passage 55B are formed by curved surfaces 55a, 55b so as to be smoothly continued to the bottom surface 51 of the cylinder head 5. Of the curved surfaces 55a, 55b, a curved surface located upstream (on the left side in FIG. 5) in the flow direction of the coolant flowing through the intake-side water jacket part 22a is referred to as an upstream curved surface 55a, and a curved surface located downstream (on the right side in FIG. 5) in the flow direction of the coolant is referred to as a downstream curved surface 55b.

An inner surface of the recessed coolant passage 55B, located between the upstream curved surface 55a and the downstream curved surface 55b is provided with recessed parts 55c, 55d introducing the coolant along the outer periphery of the injector fixing part 53. As the recessed parts 55c, 55d, there are provided an upstream recessed part 55c continued to the upstream curved surface 55a, the upstream recessed part 55c serving for introducing the coolant to an outer periphery (an outer periphery on the left side in FIG. 5) of the injector fixing part 53, and a downstream recessed part 55d continued to the downstream curved surface 55b, the downstream recessed part 55d serving for introducing the coolant to an outer periphery (an outer periphery on the right side in FIG. 5) of the injector fixing part 53. As aforementioned, the inner surface of the recessed coolant passage 55B is composed by the upstream curved surface 55a, the upstream recessed part 55c, the outer surface of the injector fixing part 53, the downstream recessed part 55d, and the downstream curved surface 55b, which are smoothly continued to extend along the coolant flow direction flowing through the intake-side water jacket part 22a. The same configuration is employed in each of the other cylinders. In this manner, each of the recessed coolant passages 55A, 55B, 55C, 55D is formed along the periphery of each corresponding injector fixing part 53.

Water jacket spacer—When the coolant is brought to flow through the block-side water jacket 22 along the cylinder alignment direction, the water jacket spacer 3 serves for increasing the flow rate of the coolant on the upper side (the upper side where more heat from the combustion gas is received) of the block-side water jacket 22 with respect to the flow rate of the coolant on the lower side thereof so as to evenly cool the entire cylinder bore wall 24, to thereby suppress variation in diameter among the bores.

This water jacket spacer 3 is formed by a resin material having a relatively high rigidity and exhibiting a relatively small change in shape when receiving heat or external force. As shown in FIG. 1, the water jacket spacer 3 has a shape along the outer circumferential surface of the cylinder bore wall 24 so as to surround substantially the entire outer circumferential surface of the cylinder bore wall 24.

Specifically, the water jacket spacer 3 includes: multiple intake-side spacers 31, 31, . . . , each formed in an arc shape in a plan view, the intake-side spacers 31, 31, . . . being provided in the intake-side water jacket part 22a, and continuously formed from the front side to the rear side so as to face the outer circumferential surface on the intake side of the cylinder bore wall 24; multiple exhaust-side spacers 32, 32, . . . , each formed in an arc shape in a plan view, the exhaust-side spacers 32, 32, . . . being provided in the exhaust-side water jacket part 22b, and continuously formed from the rear side to the front side so as to face the outer circumferential surface on the exhaust side of the cylinder bore wall 24; and a connecting part 33 connecting the intake-side spacers 31 to the exhaust-side spacers 32.

A height dimension of the water jacket spacer 3 is set to be shorter than a height dimension (a depth dimension of the coolant passage) of the block-side water jacket 22 by a predetermined dimension. In the state in which this water jacket spacer 3 is disposed in the block-side water jacket 22, the position of the upper edge of the water jacket spacer 3 is set to be lower than the position of the deck surface 25 of the cylinder block 2 by a predetermined dimension.

Furthermore, the water jacket spacer 3 is accommodated inside the block-side water jacket 22 in such a manner that the water jacket spacer 3 partially fills the space of the block-side water jacket 22 from a center part to a lower part thereof. Accordingly, the flow rate of the coolant flowing through the upper part of the block-side water jacket 22 is increased more than the flow rate of the coolant flowing through a region from the center part to the lower part of the block-side water jacket 22, to thereby efficiently cool the upper part of the cylinder bore wall 24.

The water jacket spacer 3 has such a feature that projections 34, 34, . . . are provide to respective upper edges of the intake-side spacers 31, 31, . . . . As shown in FIG. 5, these projections 34 are formed in correspondence to the recessed coolant passages 55A, 55B, 55C, 55D formed in the cylinder head 5. Specifically, the projections 34, 34, . . . are provided such that an apex position of each projection 34 and a center position of each corresponding injector fixing part 53 oppose each other in the vertical direction. The shape of the upper edge of the projection 34, 34, . . . is formed in an arc shape having a relatively small curvature (a large radius of curvature). Accordingly, it is possible to direct part of the coolant flow flowing in the block-side water jacket 22 (the intake-side water jacket part 22a) toward the recessed coolant passages 55A, 55B, 55C, 55D.

In the above manner, the cooling structure for the internal combustion engine as referred to in the present disclosure is composed by the block-side water jacket 22 provided in the cylinder block 2, the head-side water jacket provided in the cylinder head 5, the coolant circulation circuit, the recessed coolant passages 55A, 55B, 55C, 55D, and others.

Injector cooling operation—Next, the injector cooling operation in the above-configured engine body 1 will be described. The injector cooling operation allows part of the coolant flowing through the block-side water jacket 22 to contribute to cooling of the injectors 6.

By the operation of the water pump, the coolant, after flowing via the coolant introducing passage 23, flows through the block-side water jacket 22 along the cylinder alignment direction. At this time, of the coolant flowing through the intake-side water jacket part 22a of the block-side water jacket 22 (the coolant flowing along the cylinder alignment direction), the coolant flowing through an upper part of the water jacket spacer 3 is directed toward the recessed coolant passage 55B by the projection 34 provided on the upper edge of the water jacket spacer 3 (see an arrow in FIG. 5).

The coolant directed toward the recessed coolant passage 55B, after flowing along the upstream curved surface 55a, partially flows into the upstream recessed part 55c so as to cool the outer surface (the outer surface on the left side in FIG. 5) of the injector fixing part 53 (cool the injector 6 via this outer surface). Thereafter, this coolant flows along the bottom surface of the injector fixing part 53, and after the coolant cools this bottom surface (after cooling the injector 6 via this bottom surface), the coolant flows into the downstream recessed part 55d so as to cool the outer surface (the outer surface on the right side in FIG. 5) of the injector fixing part 53 (cool the injector 6 via this outer surface). Thereafter, the coolant flows along the downstream curved surface 55b, to be returned to the intake-side water jacket part 22a.

The coolant returned to the intake-side water jacket part 22a flows toward the downstream side of the intake-side water jacket part 22a. This coolant flow is directed toward the recessed coolant passages 55C, 55D that are located more downstream, as with the aforementioned case, thus to effectively cool the injectors 6 located more downstream. The above operation is carried out in turn across the respective cylinders so as to cool the injector fixing parts 53, 53, . . . , to thereby cool the respective injectors 6.

Inside the above-configured recessed coolant passages 55A, 55B, 55C, 55D, the flow direction of the above coolant flow is not greatly changed, and the coolant flow is smoothly guided by the respective projections 34 provided on the water jacket spacer 3 into the recessed coolant passages 55A, 55B, 55C, 55D, respectively. Therefore, it is suppressed that the flow rate becomes decreased due to disturbance caused to the coolant flow flowing along the peripheries of the injector fixing parts 53.

As aforementioned, in the cooling structure for the injectors 6 in the present embodiment, the direction of the flow of the coolant flowing along the block-side water jacket 22 in the cylinder alignment direction is not greatly changed toward the cylinder head 5 side, and the coolant is smoothly guided into the recessed coolant passages 55A, 55B, 55C, 55D by the projections 34 provided on the water jacket spacer 3. Therefore, it is suppressed that the flow rate of the coolant becomes decreased due to the disturbance caused to the coolant flow flowing along the peripheries of the injector fixing parts 53. Accordingly, the coolant flows at a relatively high flow rate along the peripheries of the injector fixing parts 53, to thereby obtain a sufficient cooling performance for the injectors 6. As a result, it is possible to suppress accumulation of deposits around the injection holes of the injectors 6, so that a proper amount of fuel injection can be acquired, thus sufficiently exerting the engine performance.

As aforementioned, the length dimension in the cylinder alignment direction of each of the intake-side communication holes 42, 42, . . . of the gasket 4 in the present embodiment substantially coincides with the length dimension in the cylinder alignment direction of each of the recessed coolant passages 55A, 55B, 55C, 55D. Therefore, the flow direction of the coolant flowing from the block-side water jacket 22 into the recessed coolant passages 55A, 55B, 55C, 55D is hardly changed. Accordingly, it is possible to enhance reliability for the coolant flow flowing at a relatively high flow rate along the peripheries of the injector fixing parts 53, 53, . . . , to thereby provide a sufficient cooling performance for the injectors 6.

The recessed coolant passages 55A, 55B, 55C, 55D are out of communication with the head-side water jacket, inside the cylinder head 5. In the related art, the coolant passages allowing the coolant to flow along the peripheries of injector fixing parts communicate with the head-side water jacket, inside the cylinder head. Hence, additional coolant passages to allow them to communicate with each other are required, and thus the capacity of the coolant passages in the entire cylinder head is likely to be greater. Consequently, the amount of the coolant becomes relatively great. To the contrary, according to the present embodiment, the recessed coolant passages 55A, 55B, 55C, 55D are out of communication with the head-side water jacket, and thus it is possible to reduce the capacity of the coolant passage in the entire cylinder head 5, thus decreasing the amount of the coolant. Accordingly, it is possible to rapidly increase the temperature of the coolant at the time of warming up the engine, and also promote improvement of the specific fuel consumption because of reduction of the warm-up running time.

(Variation) Next, a variation will be described. In the present variation, the configuration of the recessed coolant passages 55A, 55B, 55C, 55D provided in the cylinder head 5 is different from that of the above embodiment. The other configurations and operations are the same as those of the above embodiment. Hence, the configuration of the recessed coolant passages 55A, 55B, 55C, 55D will be mainly described herein.

FIG. 6 is a view corresponding to FIG. 5 in the present variation. As shown in FIG. 6, the recessed coolant passage 55B includes a branch passage 58 allowing the coolant to flow toward a position above the injector fixing part 53 (a position on the opposite side to the cylinder block 2). That is, the injector fixing part 53 is configured into a pipe shape, and a recessed portion 58a continued to the upstream curved surface 55a and the downstream curved surface 55b is formed above the injector fixing part 53, to thereby form the branch passage 58 between the injector fixing part 53 and the recessed portion 58a. This branch passage 58 is formed by using a core when the cylinder head 5 is casted. The other cylinders also have the same configuration.

According to the above configuration, as indicated by an arrow in FIG. 6, it is possible to allow the coolant to flow along the entire circumference of each injector fixing part 53. That is, it is possible to cool each injector 6 from the entire circumference thereof. Accordingly, it is possible to promote further enhancement of the cooling performance for the injectors 6.

The other embodiments—The embodiments and the variation disclosed herein are intended to be illustrative in all respects and should not be construed as the basis for restrictive interpretations. Therefore, the technical scope of the present disclosure is not intended to be interpreted based on only the above-described embodiments and variation, but rather is defined based on the description in the claims. Moreover, all changes within meanings and scopes equivalent to the claims are embraced by the technical scope of the present disclosure.

For example, in the above embodiments and the above variation, the case of applying the present disclosure to an inline 4-cylinder gasoline engine has been described, but the present disclosure is not limited to this, and may also be applicable to a V-type engine or a horizontally-opposed engine. The number of the cylinders is not limited to a specific one. The present disclosure is also applicable to a diesel engine.

In the above embodiments and the above variation, the recessed coolant passages 55B, 55C, 55D corresponding to the second to the fourth cylinders are configured to have the same shape. The present disclosure is not limited to this, and the shapes of the recessed coolant passages 55B, 55C, 55D may be different from one another. For example, the temperature of the coolant flowing into the recessed coolant passages 55B, 55C, 55D becomes gradually higher as the coolant flows from the recessed coolant passages 55B, 55C to 55D that are located more downstream in this order (the temperature of the coolant becomes gradually higher by heat-exchange with the injectors 6); therefore, it may be configured to define the recess dimensions of the recessed coolant passages 55B, 55C, 55D, which are located more downstream in this order, to be gradually greater so as to gradually increase the amount of the coolant flowing into the recessed coolant passages 55B, 55C, 55D, which are located more downstream in this order.

The present disclosure is applicable to a structure to cool injectors in a cylinder-direct-injection type engine.

What is claimed is:

1. A cooling structure for an internal combustion engine, allowing a coolant to flow along periphery of a fixing part for fuel injection valve so as to cool the fuel injection valve, the cooling structure comprising:
a cylinder head including the fixing part for the fuel injection valve of a cylinder-direct-injection type;
a cylinder block; and
a water jacket spacer, wherein
a surface on a cylinder block side of the cylinder head is recessed so as to be sectioned into a recessed coolant passage communicating with a block-side water jacket formed in the cylinder block, the recessed coolant passage surrounding periphery of the fixing part for the fuel injection valve, and
an edge on a cylinder head side of the water jacket spacer that is disposed in the block-side water jacket is provided with a projection projecting toward the recessed coolant passage so as to direct at least part of the coolant flowing inside the block-side water jacket toward the recessed coolant passage.

2. The cooling structure for the internal combustion engine according to claim 1, wherein:
the cooling structure is provided in a multiple-cylinder internal combustion engine;
in the block-side water jacket, the coolant flows along a cylinder alignment direction;
a gasket interposed between the cylinder block and the cylinder head is formed with communication holes corresponding to the recessed coolant passages; and
a length dimension in the cylinder alignment direction of each of the communication holes of the gasket coincides with a length dimension in the cylinder alignment direction of each of the recessed coolant passages.

3. The cooling structure for the internal combustion engine according to claim 1, wherein:
the cylinder head is formed with a head-side water jacket that communicates with the block-side water jacket; and
the recessed coolant passage does not communication with the head-side water jacket, inside the cylinder head.

4. The cooling structure for the internal combustion engine according to claim 1, wherein the recessed coolant passage is provided with a branch passage allowing the coolant to flow toward a side opposite to the cylinder block in the fixing part of the fuel injection valve.
